(19) United States
(12) Patent Application Publication
(10) Pub. No.: US 2007/0025426 A1
(43) Pub. Date: Feb. 1, 2007

(54) Digital broadcast system controllable by multiple users and method for controlling the same

(75) Inventor: Jong Han Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/491,063

(22) Filed: Jul. 24, 2006

(30) Foreign Application Priority Data
Jul. 28, 2005 (KR) 10-2005-0069042

(51) Int. Cl. H04B 1/707

(52) U.S. Cl. 375/148

(57) ABSTRACT

A digital broadcast system controllable by multiple users is provided, which adds a CDMA function to a conventional set-top box or digital TV receiver. This allows the set-top box or digital TV receiver to process all signals received through the same frequency at the same time. This system can be applied to a variety of applications such as a game in which multiple users can participate using their terminals.

This application claims the benefit of Korean Patent Application No. 10-2005-0069042, filed on Jul. 28, 2005, which is hereby incorporated by reference as if fully set forth herein.

### BACKGROUND OF THE INVENTION

1. Field of the Invention

The present invention relates to a digital broadcast receiver such as a digital TV or a set-top box, and more particularly, to a digital broadcast system that allows multiple users to simultaneously control a digital broadcast receiver through their terminals.

2. Discussion of the Related Art

A conventional digital broadcast receiver allows a single user to control it using a single remote controller. The conventional broadcast receiver cannot implement a variety of applications such as a game function which a plurality of users can enjoy together.

### SUMMARY OF THE INVENTION

Accordingly, the present invention is directed to a digital broadcast system controllable by multiple users and a method for controlling the same that substantially obviate one or more problems due to limitations and disadvantages of the related art.

An object of the present invention is to provide a digital broadcast system controllable by multiple users and a method for controlling the same, which allow a plurality of users to simultaneously control a digital broadcast receiver.

Another object of the present invention is to provide a digital broadcast system controllable by multiple users and a method for controlling the same, which apply a code division multiple access (CDMA) method to a digital broadcast receiver, thereby allowing the digital broadcast receiver to receive and process signals of the same frequency from a plurality of users at the same time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital broadcast system controllable by multiple users comprises at least two terminals that transmit key signals modulated according to a code division method; and a broadcast receiver that simultaneously reconstructs signals received from the terminals according to a code division demodulation method and simultaneously performs applications corresponding to the reconstructed signals.

Preferably, each of the terminals outputs a signal produced by multiplying a user-entered key signal by a corresponding PN code, which is a spread code.

Preferably, the broadcast receiver comprises at least two signal analyzers that reconstruct signals received from the terminals by multiplying the received signals by corresponding PN codes and then performing band-pass filtering on the multiplied signals.

Preferably, the broadcast receiver further comprises a PN code controller that controls PN code generation of each of the signal analyzers; and an operation controller that simultaneously performs applications corresponding to the signals that have been received from the terminals and then been reconstructed by the signal analyzers.

Preferably, each of the signal analyzers comprises a PN code generator that generates a PN code of the corresponding terminal under control of the PN code controller; a multiplier that multiplies a received signal by the PN code generated by the PN code generator; and a band pass filter that performs band-pass filtering on an output of the multiplier.

In another aspect of the present invention, a method for controlling a digital broadcast system comprises receiving an entered event-generation key signal; generating a code division signal by multiplying the entered key signal by a spread code; and transmitting the generated code division signal.

In another aspect of the present invention, a method for controlling a digital broadcast system comprises receiving at least two code division signals and multiplying the received code division signals respectively by corresponding spread codes; demodulating the received signals by performing band-pass filtering on the multiplied signals; and simultaneously performing corresponding applications based on the demodulated signals.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram of an embodiment of a digital broadcast system controllable by multiple users according to the present invention;

FIG. 2 is a conceptual diagram of terminals and a broadcast receiver in the digital broadcast system controllable by multiple users according to the present invention; and

FIG. 3 illustrates an embodiment of a detailed circuit of a multi-user controller in the broadcast receiver in the digital broadcast system controllable by multiple users according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

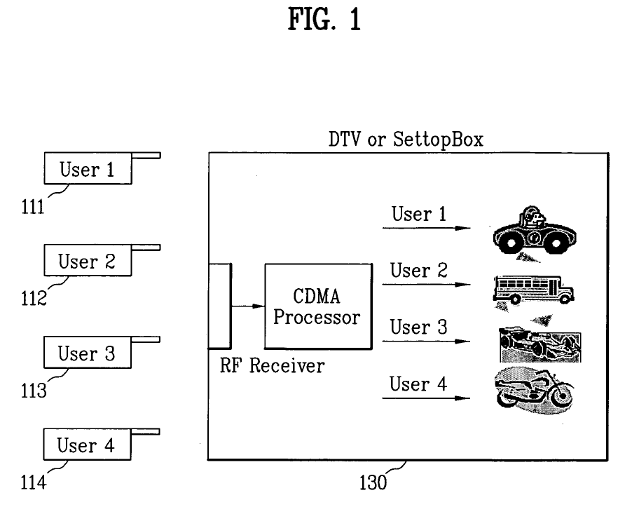

FIG. 1 is a schematic diagram of a digital broadcast system according to the present invention, which includes terminals 111 to 114, which transmit signals according to a code division method, and a broadcast receiver which receives signals transmitted from at least two of the terminals 111 to 114 and simultaneously performs applications requested by the at least two terminals.

Examples of the terminals 111 to 114 include remote controllers, mobile phones, or terminals specially designed for using a specific application. Any one of the terminals 111 to 114 can transmit signals modulated according to the code division method.

The broadcast receiver 120 includes a multi-user controller 130, which includes a receiver 131 and a CDMA processor 132. The receiver 131 receives signals transmitted from the terminals 114 to 114. The CDMA processor 132 receives the signals received by the receiver 131, analyzes corresponding commands of the terminals, and controls the operation of the broadcast receiver 120 according to the commands.

In the embodiments of the present invention, code division multiple access (CDMA) is used as the code division method. CDMA is a communication technology in which data for transmission is modulated using pseudo noise (PN) signals and the modulated data is transmitted through a spread band (i.e., a spread spectrum).

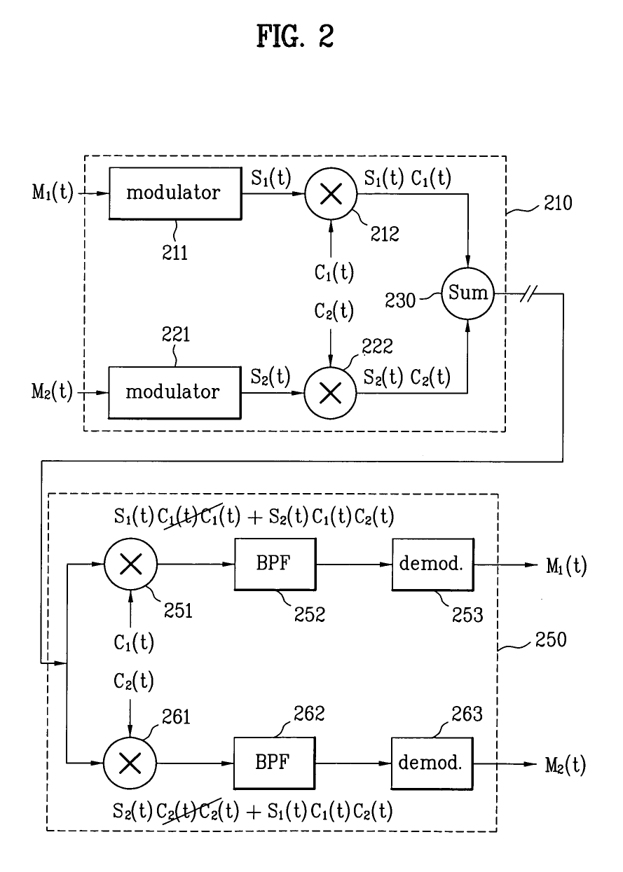

FIG. 2 is a schematic diagram of the CDMA communication method according to the present invention when two users simultaneously transmit signals using two terminals 111 and 112.

In FIG. 2, each of the terminals includes a modulator and a multiplier, and the CDMA processor 132 in the multi-user controller 130 includes N signal analyzers (2 signal analyzers in the example of FIG. 2) which analyze signals transmitted from the terminals and perform control operations according to the analyzed signals. Each of the signal analyzers includes a multiplier, a band pass filter (BPF), and a demodulator.

The modulator in each terminal multiplies a code value corresponding to an entered key value of the terminal by a predetermined carrier and outputs the multiplied code value to the multiplier in the terminal. The multiplier in the terminal multiplies the signal output from the modulator by a corresponding PN code and transmits the multiplied signal to the broadcast receiver 120. For example, a code value M₁(t) of the first terminal 111 is modulated through the modulator and the modulated signal S₁(t) is output to the multiplier. The multiplier then multiplies the modulated signal S₁(t) by a first PN code C₁(t) and transmits the multiplied signal S₁(t)C₁(t).

The carrier by which the input signal of the modulator is multiplied is commonly applied to every terminal. Thus, every terminal outputs the same frequency. However, the PN code by which the input signal of the multiplier is multiplied is unique to each terminal. That is, the PN codes C₁(t) and C₂(t) used in the multipliers in the first and second terminals are different from each other.

If two or more terminals simultaneously transmit signals, then the receiver 131 in the multi-user controller 130 in the broadcast receiver 120 receives a combination “S₁(t)C₁(t)+S₂(t)C₂(t)” of the signals transmitted from the terminals.

In FIG. 2, “M₁(t)” and “M₂(t)” denote code values corresponding to entered key values of the first and second terminals 111 and 112, and “S₁(t)” and “S₂(t)” denote output signals of the modulators of the first and second terminals.

In FIG. 2, “S₁(t)C₁(t)” and “S₂(t)C₂(t)” denote signals that are produced by multiplying the output signals S₁(t) and S₂(t) of the modulators by different PN codes C₁(t) and C₂(t) and are then transmitted to the broadcast receiver.

In the CDMA processor 132 of the broadcast receiver, a received signal “S₁(t)C₁(t)+S₂(t)C₂(t)” is multiplied by the PN codes C₁(t) and C₂(t) assigned to the terminals to output combinations of the modulated signals of the terminals and other noise signals “S₁(t)+S₂(t)C₁(t)C₂(t)” and “S₂(t)+S₁(t)C₁(t)C₂(t)”, and the output signals are then band-pass filtered to obtain only the modulated signals S₁(t) and S₂(t) of the terminals.

Specifically, the multipliers of the signal analyzers in the CDMA processor 132 receive a combination “S₁(t)C₁(t)+S₂(t)C₂(t)” of the output signals of the terminals. Each of the multipliers destroys the corresponding PN code C₁(t) or C₂(t) from the received signal “S₁(t)C₁(t)+S₂(t)C₂(t)” by multiplying it by the same PN code C₁(t) or C₂(t). More specifically, the first multiplier in the first signal analyzer 211 destroys the PN code C₁(t) by multiplying the input signal “S₁(t)C₁(t)+S₂(t)C₂(t)” by the same PN code C₁(t) and outputs a signal “S₁(t)+S₂(t)C₁(t)C₂(t)”. The band pass filter in the first signal analyzer filters this signal and outputs only the signal S₁(t) to the demodulator. The demodulator obtains the original code value M₁(t) by performing demodulation, which is the inverse of the modulation in the modulator, on the signal S₁(t).

For example, if the PN code C₁(t) assigned to the first terminal 111 is “1110100” and the modulated signal “S₁(t)” of the first terminal 111 is “1010101” and if the value “0” is replaced with “−1”, the terminal 111 transmits a signal “C₁(t)×S₁(t)” (1,−1,1,1,1,1,−1) that is produced by multiplying the modulated signal “S₁(t)” (1,−1,1,−1,1−1,1) by the PN code “C₁(t)” (1,1,1,−1,1,−1,−1).

The first signal analyzer 211 in the CDMA processor 132 of the broadcast receiver multiplies the signal “C₁(t)×S₁(t)” (1,−1,1,1,1,1,−1) received from the first signal analyzer 211 by the PN code “C₁(t)” (1,1,1,−1,1,−1,−1) and performs band-pass filtering on the multiplied signal to obtain the signal “S₁(t)” (1,−1,1,−1,1−1,1) (=1010101).

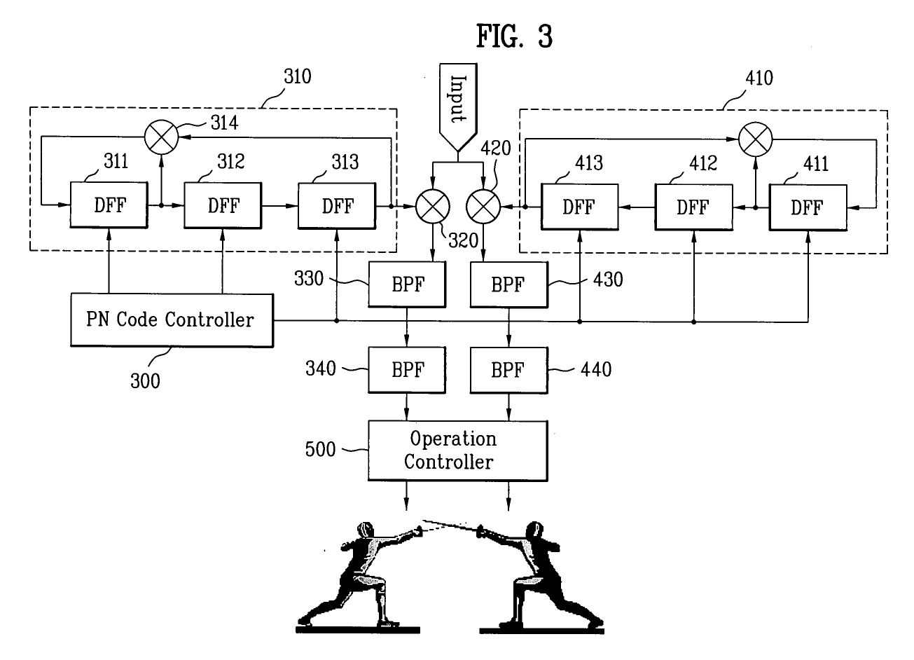

FIG. 3 illustrates an embodiment of a detailed circuit of a CDMA processor when two terminals are used. Here, using two terminals is just an example.

As shown in FIG. 3, the CDMA processor includes first and second PN code generators 310 and 410, first and second multipliers 320 and 420, first and second BPFs 330 and 430, first and second demodulators 340 and 440, a PN code controller 300, and an operation controller 500.

The CDMA processor includes the same number of PN code generators, the same number of multipliers, the same number of BPFs, and the same number of demodulators as the number of terminals that can be handled by the CDMA processor.

Under the control of the PN code controller 300, the first PN code generator 310 generates and outputs a first PN code to the first multiplier 320 and the second PN code generator 410 generates and outputs a second PN code to the second multiplier 420.

The first PN code generator 310 includes first to third flip-flops 311 to 313 connected in series and an adder 314. The adder 314 adds up an output from the first flip-flop 311 and an output from the third flip-flop 313 and provides the resulting signal to the first flip-flop 311. The output of the third flip-flop 313 is provided to the first multiplier 320. In this embodiment, the three flip-flops 311 to 313 are D-type flip-flops. Here, using only the three D flip-flops is just an example.

The second PN code generator 410 includes three D flip-flops 411 to 413 connected in series and an adder 414.

The PN code controller 300 sets an initial value (for example, a binary value) to the D flip-flops 311 to 313 of the first PN code generator 310 corresponding to the first terminal and sets a different initial value to the D flip-flops 411 to 413 of the second PN code generator 410 corresponding to the second terminal. That is, the PN code controller 300 sets a different initial value for each terminal. Each of the PN code generators generates a PN code by feedback-shifting its initial value by a corresponding delay time. Accordingly, the first and second PN code generators 310 and 410 generate different PN codes, thereby making it possible to differentiate the PN codes transmitted from the terminals. The PN code generator outputs the generated PN code after replacing each chip value “0” therein with “−1” while leaving each chip value “1” unchanged through autocorrelation. The second PN code generator 410 outputs a sequence of chip values with a delay of one chip compared to the output of the first PN code generator 310 through cross-correlation.

The first PN code generated by the first PN code generator 310 is input to the first multiplier 320, which then multiplies the signal received from the first terminal 111 by the first PN code, thereby removing the first PN code from the received signal. The output signal of the first multiplier 320 is then input to the first BPF 330, which passes only the modulated signal of the first terminal 111 and filters out all signals received from other terminals.

That is, part of the received signal corresponding to the PN code of the first terminal is reconstructed through the first PN code generator 310 and the first multiplier 320 and the remaining part thereof not associated with the PN code of the first terminal is removed through the first BPF 330.

The band-pass filtered signal is then reconstructed into the code value of the first terminal 111 through the first demodulator 340 and the reconstructed code value is then input to the operation controller 500. The operation controller 500 is previously programmed to perform an operation corresponding to the code value. For example, taking into consideration that different code values are received when different key values have been entered on the first terminal 111, the broadcast receiver previously produces and stores mapping information between operations corresponding to the key values and the code values corresponding to the key values. For example, when the requested program is a game program, the operation controller 500 is programmed to perform a “stab” operation if the entered key value is an up arrow key, a “cut right” operation if it is a right arrow key, and a “cut left” operation if it is a left arrow key.

The procedure for reconstructing the signal received from the first terminal 111 has been described above and the same is applied to signals received from other terminals.

A PN code generator (not shown) in each terminal has the same configuration as the PN code generator in the broadcast receiver. An initial value set in D flip-flops of the PN code generator in the first terminal is identical to that set in the D flip-flops of the first PN code generator 310 used to generate the PN code of the first terminal. Similarly, an initial value set in D flip-flops of the PN code generator in the second terminal is identical to that set in the D flip-flops of the second PN code generator 410 used to generate the PN code of the second terminal. However, the initial values of the D flip-flops of the first and second PN code generators 310 and 410 are different from each other. This indicates that the initial values of the D flip-flops of the PN code generators in the first and second terminals are different from each other. The terminals transmit their PN codes with different delay times to the broadcast receiver.

The terms used in the above description are defined taking into consideration the functions provided in accordance with the present invention. The definitions of the terms should be determined based on the whole content of this specification because they may be changed according to the intentions of those skilled in the art or the usual practice.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A digital broadcast system controllable by multiple users, the system comprising:
at least two terminals that transmit key signals modulated according to a code division method; and
a broadcast receiver that simultaneously reconstructs signals received from the terminals according to a code division demodulation method and simultaneously performs applications corresponding to the reconstructed signals.

2. The digital broadcast system according to claim 1, wherein each of the terminals outputs a signal produced by multiplying an entered key signal by a corresponding spread code.

3. The digital broadcast system according to claim 1, wherein the broadcast receiver comprises at least two signal analyzers that reconstruct signals received from the terminals by multiplying the received signals by corresponding spread codes and then performing band-pass filtering on the multiplied signals.

4. The digital broadcast system according to claim 3, wherein the broadcast receiver further comprises:
a spread code controller that controls spread code generation of each of the signal analyzers; and
an operation controller that simultaneously performs applications corresponding to the signals that have been received from the terminals and then been reconstructed by the signal analyzers.

5. The digital broadcast system according to claim 4, wherein each of the signal analyzers comprises:
a spread code generator that generates a spread code of the corresponding terminal under control of the spread code controller;
a multiplier that multiplies a received signal by the spread code generated by the spread code generator; and
a band pass filter that performs band-pass filtering on an output of the multiplier.

6. The digital broadcast system according to claim 5, wherein the spread code generator comprises:
first to third flip-flops connected in series, an initial value being set to the first to third flip-flops under control of the spread code controller; and
an adder that adds up outputs of the first to third flip-flops and feeds the resulting signal to the first flip-flop.

7. The digital broadcast system according to claim 6, wherein the spread code controller sets a different initial value to the flip-flops of each of the signal analyzers.

8. A method for controlling a digital broadcast system, the method comprising:
receiving an entered event-generation key signal;
generating a code division signal by multiplying the entered key signal by a spread code; and
transmitting the generated code division signal.

9. The method according to claim 8, wherein the spread code has autocorrelation and cross-correlation properties.

10. A method for controlling a digital broadcast system, the method comprising:
receiving at least two code division signals and multiplying the received code division signals respectively by corresponding spread codes;
demodulating the received signals by performing band-pass filtering on the multiplied signals; and
simultaneously performing corresponding applications based on the demodulated signals.

11. The method according to claim 10, wherein the received code division signals are demodulated with respective delay times of the corresponding spread codes.

12. The method according to claim 11, wherein the corresponding spread codes are generated through feedback shift of preset initial values.
